(19) United States
(12) Patent Application Publication
(10) Pub. No.: US 2025/0207981 A1
(43) Pub. Date: Jun. 26, 2025

(54) TEXTILE THERMAL SENSOR

(71) Applicant: Footfalls and Heartbeats (UK) Limited, Nottingham (GB)

(72) Inventors: Madeleine Alice OAKLEY, Nottingham (GB); Thomas John PAYNE, Nottingham (GB); Simon Adair MCMASTER, Nottingham (GB)

(21) Appl. No.: 18/849,990

(22) PCT Filed: Mar. 24, 2023
(86) PCT No.: PCT/GB2023/050773

§ 371 Date: Sep. 23, 2024

(30) Foreign Application Priority Data
Mar. 24, 2022 (GB) 2204189.1

(51) Int. Cl. G01K 7/08; B60L 58/10; D04B 1/16; G01K 13/20

(52) U.S. Cl. CPC G01K 7/08; B60L 58/10; D04B 1/16; G01K 13/20; B60L 2240/545; D10B 2403/02431

(57) ABSTRACT

The invention provides a knitted textile thermal sensor. The thermal sensor comprises: a first electrically conductive yarn comprised of a first electrically conductive material; a second electrically conductive yarn that is comprised of a second electrically conductive material different from the first electrically conductive material; and electrically conductive output yarns that are in electrical connection with the first and second electrically conductive yarns. The first and second electrically conductive yarns are comprised within or applied to a textile via a plurality of stitches that form a defined sensing stitch pattern. The sensing stitch pattern comprises at least one thermal sensing junction that provides an electrical connection between the first and second electrically conductive yarns, and at a location remote from the at least one thermal sensing junction, a reference junction. The output yarns facilitate electrical connection to the thermal sensor such that at least one voltage measurement can be made.

### TECHNICAL FIELD

The present disclosure relates to a textile and composite material based thermal sensor devices. The disclosure further relates to thermal sensors that are incorporated into textiles, such as garments, or for use in composite materials that are suitable for adequately measuring temperature at a defined location.

### BACKGROUND

An increasingly important area in textile design is that of “intelligent textiles” in which electrical signals representing physiological data are collected from garments and transmitted to remote locations for the purpose of, for example, monitoring, assessment, and intervention by health care professionals. Often, such textile devices are generally not truly intelligent textiles, as they comprise solid-state electronics placed in a textile shell and worn as apparel. As a result, such devices are often bulky or incongruous and can impair normal movement.

Truly intelligent textiles are in development in which the sensor is embedded within and forms part of the textile. In other words, the textile itself is the sensor. Examples of intelligent textile sensors of this kind are found in published patents and applications of the applicant, such as international patent applications WO 2014/122619 and WO 2017/037479.

Composite materials typically comprise two or more physically and chemically distinct phases, separated by an interface. These different phases are combined in order to generate a composite with stronger structural or functional properties that the individual phases alone. Woven or knitted materials are also suitably incorporated into the manufacture of composites. Carbon, polymer, natural or glass fibre structures, in the form of a textile or cloth are commonly combined with a resin matrix material to form three dimensional structures that are strong, stiff and lightweight. Woven or non-woven fibre textiles are commonly used in the manufacture of aircraft frames, electronic devices and packaging, transmission towers, medical equipment, space vehicles, and in building construction. Most commercially manufactured composites use a polymer matrix material often referred to as a resin solution. Such polymer matrix composites (PMCs) are low cost and easy to manufacture, and benefit from fibre-reinforcement that improves the strength, modulus and impact resistance of the material compared to unreinforced polymers.

Hence, intelligent textile-based sensors may find utility not only in fabrics intended for use as garments or upholstery, but also when incorporated into composite materials as a fibre reinforcement layer.

The measurement of temperature either within textiles or within/upon composite structures is normally carried out using solid state thermocouples. Conventional thermocouple technology is well known in the art, see FIG. 1, and the measurement system is robust and relatively cheap to implement. Solid state thermocouples of this type are typically collated in different types and with different temperature ranges. Each individual thermocouple unit is connected to an electronic module, or controller, which collects and transmits the received data. One limitation of solid state thermocouples is that they are typically only able to measure the local temperature at the point where they are installed. Hence, when incorporated into a composite structure an array of thermocouples must be installed across a structure or surface in order to sense temperature fluctuations across and within the composite material.

Externally mounted thermal sensors, such as solid state thermocouples, are subject to exposure to environmental and physical stresses. Any damage to a sensor can affect accuracy of readout and reduces operational lifetime. Hence, a temperature management system that includes thermal sensors such as thermocouples that are integrated into a textile would be desirable. This is especially useful if the textile is integrated into a composite structure and thereby protected against the vagaries of weather and physical wear.

It is an aim of the present invention to address one or more of the disadvantages associated with the prior art.

### SUMMARY OF THE INVENTION

The present invention provides a textile. The textile comprises an integral textile thermal sensor. The integral textile sensor may be in the form of a knitted thermocouple. Suitably the knitted thermocouple is either weft or warp knitted. The knitted thermocouple typically comprises at least one electrically conductive yarn and a plurality of stitches that form a defined thermal sensing stitch pattern, typically operating according to the principles of a thermocouple.

Hence, in a first aspect the invention provides a knitted textile thermal sensor, wherein the thermal sensor comprises,

a first electrically conductive yarn comprised of a first electrically conductive material;

a second electrically conductive yarn that is comprised of a second electrically conductive material different from the first electrically conductive material;

and electrically conductive output yarns that are in electrical connection with the first and second electrically conductive yarns;

wherein the first and second electrically conductive yarns are comprised within or applied to a textile via a plurality of stitches that form a defined sensing stitch pattern, wherein the sensing stitch pattern comprises at least one thermal sensing junction that provides an electrical connection between the first and second electrically conductive yarns, and at a location remote from the at least one thermal sensing junction, a reference junction; and

wherein the output yams facilitate electrical connection to the thermal sensor such that a voltage measurement can be made.

In a second aspect, the invention provides a weft knitted textile thermal sensor, wherein the thermal sensor comprises: a first electrically conductive yarn comprised of a first electrically conductive material; a second electrically conductive yarn that is comprised of a second electrically conductive material different from the first electrically conductive material; electrically conductive output yarns that are in electrical connection with the first and second electrically conductive yarns; and an electrical sensor; wherein the first and second electrically conductive yarns are comprised within or applied to a weft knitted textile, the weft knitted textile defining a plurality of courses and wales, wherein the first electrically conductive yarn is comprised within a first course and the second electrically conductive yarn is comprised within a second course that is spaced apart from the first course, and wherein at least one thermal sensing junction is provided by way of an electrical connection between the first and second electrically conductive yarns through a sensing stitch pattern that traverses the first and second courses, and wherein a reference junction is provided at a location remote from the at least one thermal sensing junction; and wherein the output yarns facilitate electrical connection to an electrical sensor such that at least one voltage measurement can be made.

In a third aspect, the invention provides a warp knitted textile thermal sensor, wherein the thermal sensor comprises: a first electrically conductive yarn comprised of a first electrically conductive material; a second electrically conductive yarn comprised of a second electrically conductive material different from the first electrically conductive material; electrically conductive output yarns that are in electrical connection with the first and second electrically conductive yarns; and an electrical sensor; wherein the first and second electrically conductive yarns are comprised within or applied to a warp knitted textile, the warp knitted textile defining a plurality of courses and wales, wherein the first electrically conductive yarn is comprised within a first course and the second electrically conductive yarn is comprised within a second course that is spaced apart from the first course, and wherein at least one thermal sensing junction is provided by way of an electrical connection between the first and second electrically conductive yarns through a sensing stitch pattern that traverses the first and second courses, and wherein a reference junction is provided at a location remote from the at least one thermal sensing junction; and wherein the output yarns facilitate electrical connection to an electrical sensor such that at least one voltage measurement can be made.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a diagrammatic view of a conventional solid state thermocouple arrangement;

FIG. 2 is a graph showing results of a range of thermocouples that are encapsulated within laminating resin according to embodiments of the invention;

FIG. 3 is a graph showing results of a range of thermocouples that are encapsulated within laminating resin according to embodiments of the invention in comparison to a reference K-type thermocouple device;

FIG. 4 is photograph showing the encapsulating resin block that comprises the thermocouples of embodiments of the invention;

FIG. 5 is a graph showing results of a range of thermocouples that are encapsulated within a fibreglass matrix according to embodiments of the invention;

FIG. 6 is a graph showing results of a range of thermocouples that are encapsulated within a fibreglass matrix according to embodiments of the invention in comparison to a reference K-type thermocouple device;

FIG. 7 shows a range of warp knitting structures (a) to (d) and the notation used to knit those structures;

FIG. 8 shows a warp knitted mesh structure at high magnification (a) and low magnification (b).

FIG. 9 shows a knitting pattern for an embodiment of the invention of the type shown in FIG. 7(a). In Bar 1 (left panel) a pattern is shown comprising a first electrically conductive yarn (arrow A). In Bar 2 (middle panel) the pattern for the second electrically conductive yarn is shown with a cross over that allows for formation of a hot junction. In the right-hand panel the combined knitting pattern is shown with the first yarn (A) and second yarn (B) indicated with arrows.

FIG. 10 shows a knitting pattern for another embodiment of the invention of the type shown in FIG. 7(a). In Bar 1 (left panel) two first electrically conductive yarns are shown (indicated by arrows). In Bar 2 (middle panel) the pattern for two second electrically conductive yarns is shown with cross overs that allow for formation of hot and cold junctions. In the right-hand panel the combined knitting pattern is shown with the first yarns indicated with arrows. The bottom panel shows a combined view but also indicates that the distance between hot and cold junctions can be varied as required.

FIG. 11 shows a knitting pattern for a further embodiment of the invention based around mesh knitted structure of the type shown in FIGS. 7(b) to (d) showing a single thermocouple configuration. The stitch pattern comprises first and second conductive yarns (yarns A and B) and two non-conductive yarns. The weft insertion is shown in the bottom right panel (Bar 3), with the combined view shown in the upper panel.

FIG. 12 shows a knitting pattern for a further embodiment of the invention based around mesh knitted structure of the type shown in FIGS. 7(b) to (d) but in the form of an array of thermocouple configurations. The stitch pattern comprises first and second conductive yarns (yarns A and B) and two non-conductive yarns. The weft insertion is shown in the bottom right panel (Bar 3), with the combined view shown in the upper panel.

FIG. 13 shows a graph showing results of a range of thermocouples that are encapsulated within a fibreglass matrix according to embodiments of the invention in comparison to a reference K-type thermocouple device.

FIG. 14 shows a graph showing the response of a knitted thermal sensor to a thermal treatment with taped, shrink wrapped and knitted connections to a detector.

FIG. 15 shows a graph showing the response of a knitted thermal sensor to a thermal treatment with taped, soldered and double soldered connections to a detector.

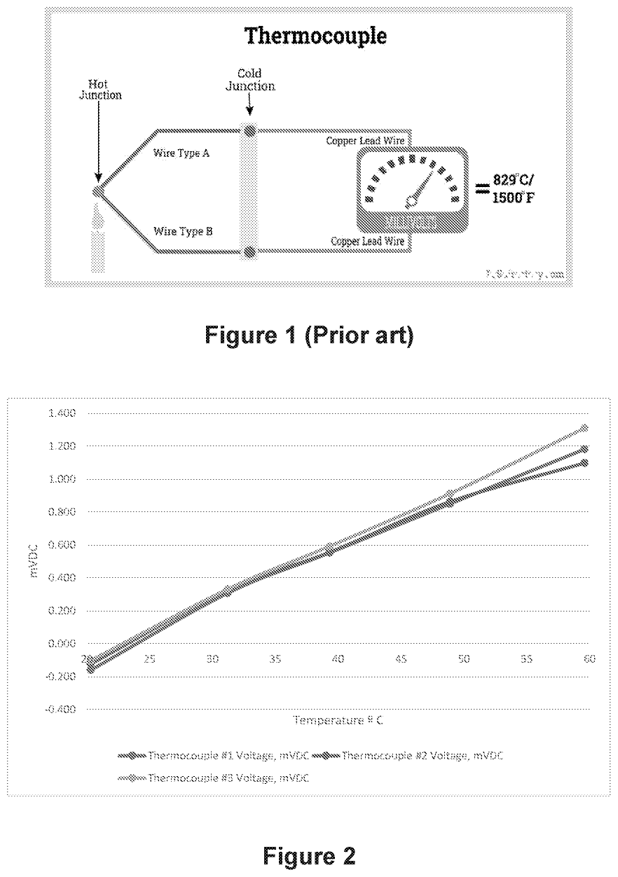

### DETAILED DESCRIPTION

All references cited herein are incorporated by reference in their entirety. Unless otherwise defined, all technical and scientific terms used herein have the same meaning as commonly understood by one of ordinary skill in the art to which this invention belongs.

Prior to setting forth the invention, a number of definitions are provided that will assist in the understanding of the invention.

As used in this description, the singular forms “a,” “an,” and “the” include plural referents unless the context clearly dictates otherwise. Thus, for example, the term “a sensor” is intended to mean a single sensor or more than one sensor or to an array of sensors. For the purposes of this specification, terms such as “forward,” “rearward,” “front,” “back,” “right,” “left,” “upwardly,” “downwardly,” and the like are words of convenience and are not to be construed as limiting terms. Additionally, any reference referred to as being “incorporated herein” is to be understood as being incorporated in its entirety.

As used herein, the term “comprising” means any of the recited elements are necessarily included and other elements may optionally be included as well. “Consisting essentially of” means any recited elements are necessarily included, elements that would materially affect the basic and novel characteristics of the listed elements are excluded, and other elements may optionally be included. “Consisting of” means that all elements other than those listed are excluded. Embodiments defined by each of these terms are within the scope of this invention.

As used herein, the term “textile” and “fabric” refers to a flexible material manufactured from a plurality of individual fibres that have been combined. A textile or fabric may be woven, knitted, crocheted, spread or made by any other kind of interlacing that may be achieved using fibres. A “fibre” used in relation to a textile refers to any substantially elongate yarn or thread. In specific embodiments of the invention the textile may be a knitted textile, suitably a warp knitted textile.

Textiles used in the present invention may be comprised of natural or synthetic materials. Suitably the textile comprises polymer fibres, such as polyethylene, polypropylene, polyester, polyvinylchloride (PVC), polyamide, carbon fibre, poly-carbo-silane; or mineral fibres such as silica fibre (e.g. glass fibre) or asbestos fibre.

For the purposes of this application, a “multifilament yarn” is defined as a yarn formed of a plurality of fine continuous filaments grouped together. The filaments are generally continuous in length along the length of the yarn, so that each filament can be considered to extend along the length of the yarn. Multifilament yarns may comprise a twist in the yarn to facilitate handling.

As used herein, the term “staple fibre yarn” is defined as yarn formed of staple fibres, each having a discrete staple length. Many staple fibres are spun together to form a length of yarn, with the length of the yarn being much greater than the length of any individual staple fibre.

The thermal sensors of the present invention may comprise a variety of basic yarn types e.g. polyester, nylon (PA 66), glass fibre and carbon fibre. To operate according to thermocouple principles, the thermal sensors will comprise electrically conductive yarn will be knitted so as to attach to and integrate within an overall textile layer of a composite structure. Suitable electroconductive yarns may be used as long as the two yarns used in the construction of the thermal sensor have sufficiently different conductivities that permit the Seebeck effect that underpins the functionality of a thermocouple. Exemplary yarns may include metal coated multifilament yarn or staple fibre yarns, or fine metal or metal alloy wires. Suitable metals may include elemental copper, nickel, or alloys thereof (e.g. constantan or Monel); iron; platinum; chrome; nickel-chrome alloys (e.g. Chromel, Nicrosil); aluminium and nickel-aluminium alloys (e.g. Alumel); and nickel-silicon alloys (e.g. Nisil). Depending upon the type of thermocouple required, the particular combination of conductive yarns may be selected. By way of example a T-type thermocouple may comprise a first conductive yarn that comprises copper and a second conductive yarn that comprises constantan. In another example, a K-type thermocouple may comprise a first conductive yarn that comprises a nickel-chromium alloy and a second conductive yarn that comprises a nickel-aluminium alloy. Other combinations may be assembled from the exemplary yarns described above, or that are known to the skilled person, as required for the particular thermal sensing application required.

In an embodiment of the present invention a thermal sensor operates according to the principles of a thermocouple, comprising at least one sensing junction and at least one reference junction within a textile. Suitably, the textile is manufactured by warp knitting. The integrated thermocouple comprises a first and second conductive yarn. The first conductive yarn comprises at least one conductive fibre comprising a first material. The second conductive yarn comprises at least one conductive fibre comprising a second material different from the first material. The first and second conductive yarns are in electrical connection with each other at a sensing junction comprised within the textile and also at a second reference junction within or outside of the textile at a location remote from the sensing junction.

The sensing junction is the location at which thermal sensing occurs, the reference junction represents the so called ‘cold junction’. The first and second conductive yarns are suitably in connection with or capable of connection to a detector that may be comprised within a controller. The detector completes an electrical circuit with the first and second conductive yarns. The detector comprises an electrical sensor, such as a multimeter or voltmeter that is configured to measure an electric potential difference between first and second conductive yarns. The magnitude of the potential difference detected may be correlated to the temperature at the sensing junction (i.e. the ‘hot’ junction). A multiplicity of stitch types can be used to create electrical contacts within the sensor. The most effective stitch types are those that create a multiplicity of contact points to allow a fixed electrical connection with the lowest resistance. In specific embodiments of the invention, the junction between the first and second conductive yarns is sufficiently mediated via direct physical contact of the yarns. Within the context of a knitted textile, direct physical contact of the conductive yarns is effected via the choice of knitting pattern which provides not only for the yarns to be placed in direct physical contact, allowing for an electrical connection to be made, but also for the surrounding non-conductive yarns to provide the support necessary to maintain the structural integrity of the sensing or reference junctions. In further embodiments where the textile is comprised within a composite material the textile may be permeated with a set resin that provides further structural support.

Incorporation of the thermal sensor into a composite material may be carried out at the composite textile manufacturing phase. It is noted that a thermocouple of the type described in embodiments herein can be knitted into various textile structures that are commonly used in the manufacture of composite engineering structures. Weft or warp knitting is the primary method for incorporating the thermocouple, however in alternative embodiments sewing, embroidery, printing, tailored fibre placement, weft or warp insertion may also provide a suitable methodology for structural integration.

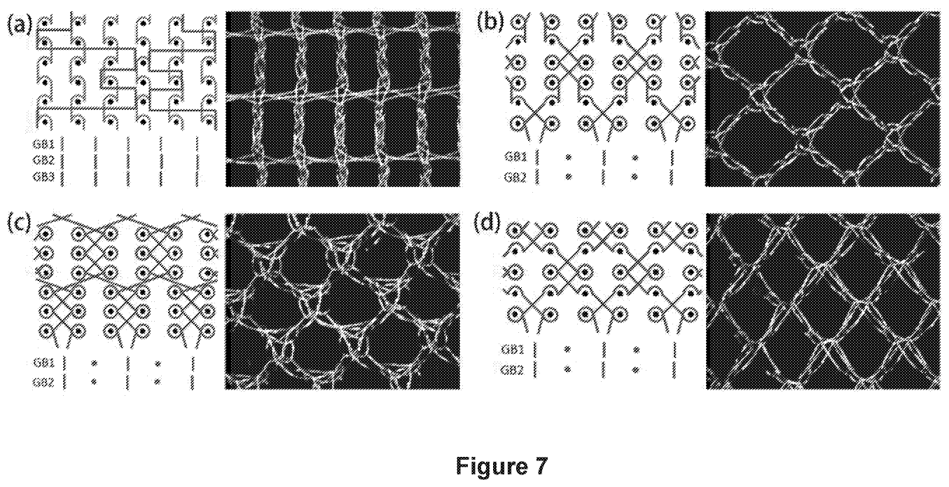

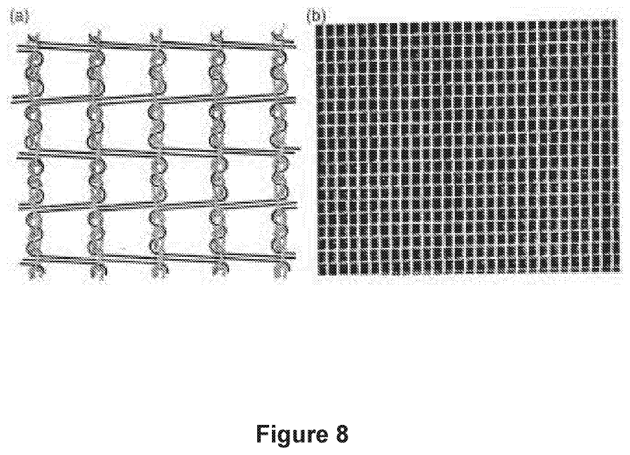

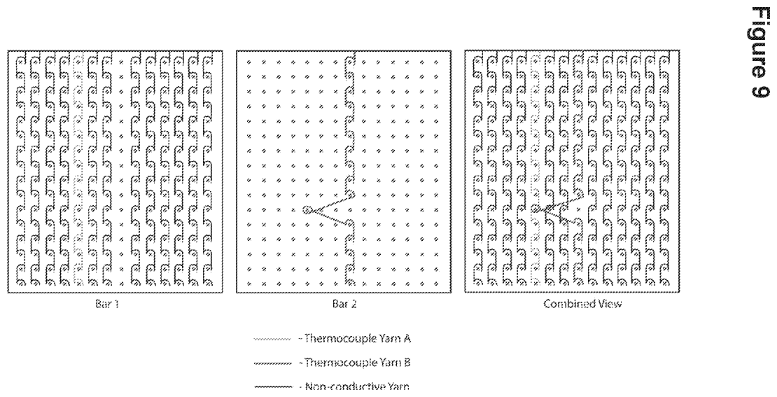

According to embodiments of the present invention, thermal sensors are knitted into a base composite fabric. There are two basic techniques that are particularly suitable to incorporate knitted sensors that operate according to the thermocouple principle. Firstly, a mesh of uniform size and shape may be knitted that has the thermocouple as part of the structure. Such a mesh conveniently constructed using a warp knitting technique. FIGS. 7 and 8 show a variety of warp knitted structures that can incorporate an integral thermal sensor functionality. In such warp knitted structures, the thermocouple comprises two different electrically conductive yarns that interconnect at a determined point to build the hot sensor junction of the thermocouple. It will be appreciated that alternative warp knitted configurations and patterns may be adopted. The yarns can be either be proprietary or non-proprietary yarns, staple fibre or filament spun in such a way as to provide first and second yarns with dissimilar thermoelectric effects to produce a reliable measure of the Seebeck effect which underpins the functioning of a conventional thermocouple. The dissimilar thermoelectric yarns are placed into contact with each other using a stitch structure that locks the “hot junction” in place and removes any risk of movement during use, such as during resin infusion when the textile is intended to be part of a composite material like a carbon fibre structure. An important consideration is ensuring robust contact between the dissimilar electrically conductive yams within the knitted structure. To this end, certain types of stitches may be used that increase the contact areas between the two types of electrically conductive yarn. For example, the knitted structure at the thermocouple junction may comprise a higher percentage of tuck and knit stitches. Without wishing to be bound by theory, there is no preferred percentage of different types of stitches but the higher the number of contact areas between the different metal yarns the better the conductivity and therefore the better the output of the sensor. The nature of basing a thermocouple sensor as an integral part of a knitted structure results in a sensor that has a high resistance to damage when in situ as part of a composite structure. Robust connection is also necessary to the detector in order to ensure good measurement of the temperature.

Mesh structures of the type shown in FIG. 8 may be used within the composite textile or act as a “scrim” or backing to any form of composite tape, prepreg carbon/glass fibre or other composite layer. It is also noted they may be warp knitted into a multiaxial carbon fibre textile as part of the standard manufacturing process.

Warp knitting is a versatile process that allows the rapid manufacture of significant volume of material. During the warp knitting process there is the possibility of allowing weft insertion to take place. Weft insertion means a yarn can be placed within the structure at an angle perpendicular to the direction of travel of the knitting process. Methods for warp knitting and weft insertion are described in Kurbak A. Models for basic warp knitted fabrics Part I: Chain stitches and their applications on marquisette and weft-inserted warp-knitted fabrics; Textile Research Journal. 2018;89(10): 1863-85. Hence, in one embodiment weft insertion allows for the placement of one or both of the conductive yarns within the textile. An advantage of weft insertion is that it allows for high levels of accuracy and positional control of placement of conductive yarns that make up the hot junction required for the thermocouple. In addition weft insertion may also allow the thermocouple to be knitted in an orientations that is perpendicular to the direction of travel of the knitted textile.

Embodiments of the invention shown in FIGS. 9, 10, 11, and 12 provide examples of various knitting stitch patterns and weft insertion stitch patterns. The embodiments shown provide novel methods for both sensor placement and also sensor connection into a textile-based network array. As shown in FIG. 9, a knitted thermocouple sensor can be realised by creating thermocouple hot junctions at individual points of the knitted textile by virtue of contact between two different types of electrically conductive yams. In FIG. 9, a first electrically conductive yarn (referenced as Thermocouple Yarn A in FIG. 9) is positioned in a first course of the stitch pattern, with a second electrically conductive yarn (Thermocouple Yarn B) in a second course, spaced apart from the first course. In FIG. 9, the two electrically conductive yarns are spaced apart by two courses of non-conductive yarn but it will be appreciated that other degrees of spacing are possible, provided there is no contact between the two electrically conductive yarns other than at the hot junction.

Contact between the two electrically conductive yarns is made by bringing the second electrically conductive yarn from the second course to the first course in one particular wale of the stitch pattern via a closed lap stitch to create a point contact between the two electrically conductive yarns. Such a thermocouple sensor allows for the thermocouple sensor to be placed at any point in a composite structure, which can be determined in three dimensions. In principle, therefore, it is possible to measure the temperature at a single point of a structure using the stitch pattern shown in FIG. 9. The skilled person will appreciate how the temperature may be independently measured at a variety of locations within a structure by incorporating a number of pairs of electrically conductive yarns as shown in FIG. 9 and making one junction between each pair of electrically conductive yams. Although FIG. 9 shows a warp knitted stitch pattern utilising a closed lap stitch to make the contact between the first and second electrically conductive yarns, it should be appreciated that other types of stitches that cause the yarn to traverse courses of the stitch pattern can also be used for the same purpose, such as a jacquard displacement, as this enables the two conductive yarns in different courses to be brought into contact with each other.

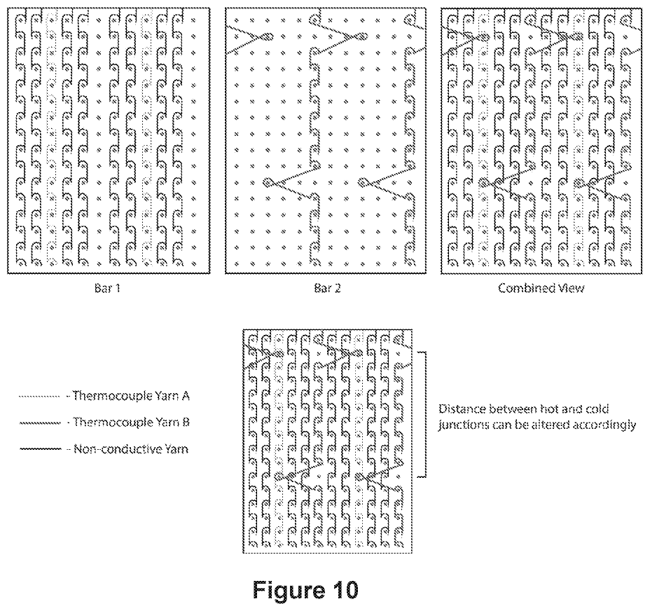

Alternatively, FIG. 10 shows how an array of hot and cold junctions may be created in a knitted structure through contact between multiple different individual yarns of two different electrically conductive yarns. As in FIG. 9, a first electrically conductive yarn is positioned in certain courses of the stitch pattern, with a second electrically conductive yarn positioned in other courses of the stitch pattern. Considering only the electrically conductive yarns, the stitch pattern of FIG. 10 shows an alternating pattern between the first and second electrically conductive yarns going across the courses of the stitch pattern. To create the array of hot and cold junctions, the second electrically conductive yarn is brought across in a closed lap stitch in a first direction to the course in which the nearest first electrically conductive yarn is positioned at one particular wale of the stitch pattern. At a different wale, the same second electrically conductive yarn is brought across in a closed lap stitch in a second direction, opposed to the first direction to the course in which the nearest first electrically conductive yarn is positioned.

Consequently, each of the first and second electrically conductive yarns are in contact, and make junctions, with two different other electrically conductive yarns, those electrically conductive yarns being the neighbouring electrically conductive yarn of the other type in both directions across the courses of the stitch pattern. Therefore, any of the first electrically conductive yarns is in contact with the neighbouring second electrically conductive yarn on either side and vice versa. As shown in FIG. 10, in addition to the alternating pattern between the first and second electrically conductive yarns in the stitch pattern, the electrically conductive yarn with which any one individual electrically conductive yarn is in contact with may also alternate going down the wales of a particular course. For example, when viewed down a particular course, each one of the second electrically conductive yarns creates a junction first with the neighbouring first electrically conductive yarn on one side and then with the neighbouring first electrically conductive yarn on the other side. The number of wales between the junctions can be altered to allow precision placement of the junctions within the knitted structure.

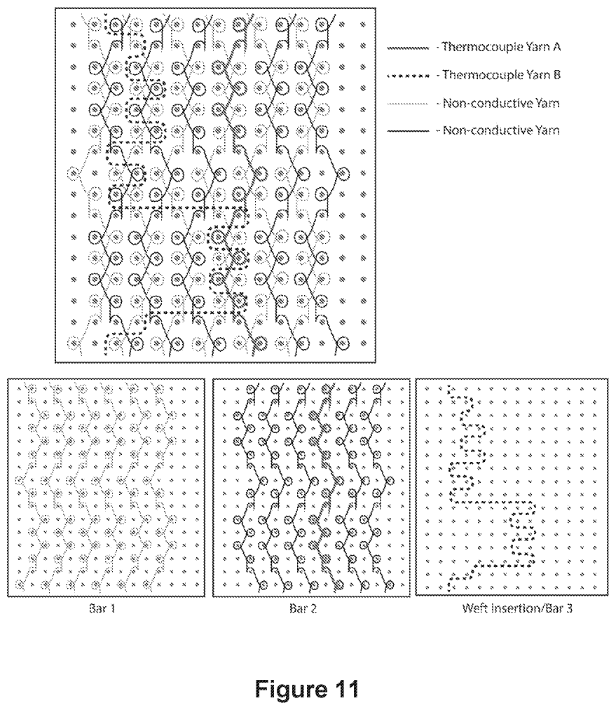

FIG. 11 shows a single first electrically conductive yarn inserted via weft insertion into a knitted structure comprising one course of a second electrically conductive yarn. In the stitch pattern of FIG. 11, the first electrically conductive yarn is inserted in a region comprising non-conductive yarns only and is then brought across to the second electrically conductive yarn. The first electrically conductive yarn is intertwined with the second electrically conductive yarn over a small number of wales to create a hot junction via the contact therebetween. The first electrically conductive yarn is then brought away from the second electrically conductive yarn, back to the region of non-conductive yarns. As with the stitch pattern shown in FIG. 9, it should be appreciated that a number of independent hot junctions can be created by incorporating a number of weft-inserted first electrically conductive yarns and bringing each of them into contact with a second electrically conductive yarn.

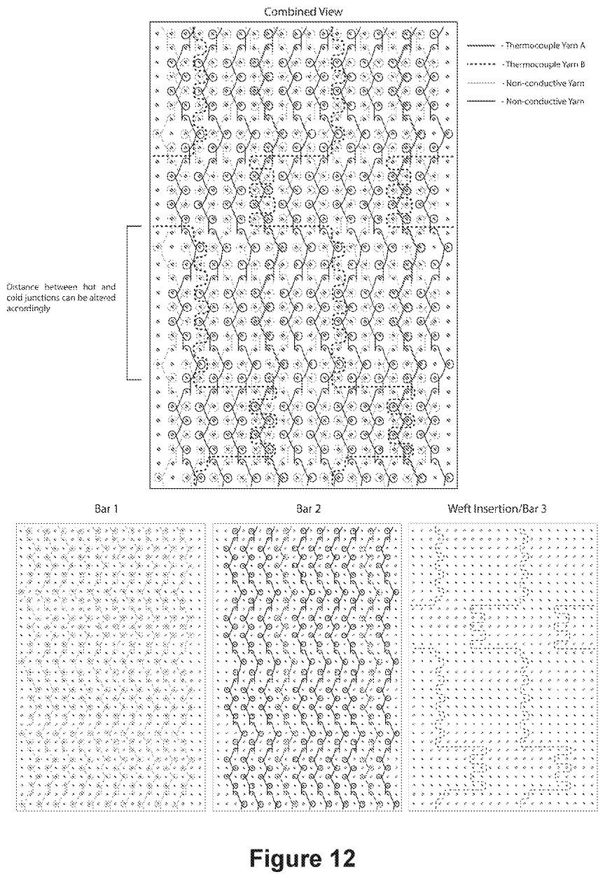

FIG. 12 shows an array of weft-inserted electrically conductive yarns creating a array of thermocouple sensors in a similar way to the knitted structure of FIG. 10. As depicted in FIGS. 10 and 12, a networked array of thermocouple sensors allows for an average temperature to be gathered over a large area, particularly when incorporated into a composite material. Alternatively, an array of individual thermocouple sensors, such as those shown in FIGS. 9 and 11 can allow for the monitoring of temperatures at various individual points of a composite structure. Hence, temperature fluctuations can be measured and monitored within a composite structure such that hot or cold spots can be identified. By way of example, composite materials may be used in the construction of wind turbine components where presence of a significant low temperature over time will lead to the icing. Build of ice on the rotor blades of a wind turbine has two main detrimental effects: firstly it changes the aerodynamic efficiency of the blades and therefore energy production; and secondly, it presents a health and safety risk to any workers or vehicles near the structures when the ice loosens and falls.

Hence, in embodiments of the invention a warp knitted textile is provided in which a thermocouple is incorporated via the weft insertion of at least a first conductive yarn. Optionally, the first conductive yarn forms at least one hot contact with a second conductive yarn. In further embodiments of the invention, there is provided a thermocouple sensor array comprised within a warp knitted textile, wherein the array comprises a plurality of weft inserted first conductive yarns and a plurality of second conductive yarns, and wherein the plurality of first conductive yarns form a plurality of hot contacts with the plurality of second conductive yarns.

While FIGS. 9 to 12 show embodiments of warp knitted stitch patterns that can be used to create hot junctions for a knitted thermal sensor, it should be appreciated that the underlying principles can be applied equally to a weft-knitted stitch pattern, with junctions created by bringing a first conductive yarn across at least one course of a non-conductive yarn into contact with a second conductive yarn. In weft knitting, tuck stitches will aid this type of yarn interconnection, but it is also noted that this interconnection can be created by a combination of inlay and stitch transfers. Plating is a technique used in both warp and weft knitting, in which both electrically conductive yarns are knitted on the same needle at the same. This can also contribute to this connection between the electrically conductive yarns

The thermal sensors discussed above show particular utility in the construction of aircraft and electric vehicles (EVs) which, by necessity, comprise lightweight composite structures.

In the new age of EVs, the temperature of the battery within its housing, or the ‘battery box’, and also the ambient external temperature are critical to the performance of the battery. Batteries for EVs are very heavy and therefore composite structures are favoured for the structure of the box. In addition the strength and lightness of these composite boxes allows the structure to be integrated into the vehicle chassis thereby reducing the overall weight of the vehicle and increasing efficiency

Lithium-ion batteries (LIBs), with high energy density and power density, exhibit good performance in many different areas including as a source of power for EVs. The performance of LIBs, however, is affected by temperature. An acceptable operating temperature for most LIBs normally is around −20° C. to 60° C. Both low temperature and high temperatures that are outside of this region will lead to degradation of performance and irreversible damage, such as lithium plating and thermal runaway.

The measurement of internal and external temperatures in a composite structure, such as the battery housing of a LIB, at present are made using thermal sensors comprised of solid state thermocouples. These thermocouples are fixed to the external surfaces of the composite structure and then connected to a computer-controlled battery management system (BMS). Temperature inputs detected from the thermal sensors are then used to control performance, such as via battery internal temperature and also charging and discharging times. These outputs are critical to battery life and also EV range. It will be understood that longer battery life is desirable and better for the manufacturer and the consumer.

Thermal sensors that are mounted on the outside surface of a composite structure, such as an EV battery housing, are subject to environmental stresses and forces associated with modern motoring. Any damage to a thermal sensor is critical to the BMS and can impair the battery lifetime and vehicle range. The present invention provides, in one embodiment a temperature management system that comprises thermal sensors in the form of thermocouples integrated into the composite structure and thereby protected against the vagaries of weather and vehicular wear. This innovative solution provides a significant cost advantage over current surface mounted solid state thermocouple sensors and also over time better value for the manufacturer and operator of an EV.

Hence, in accordance with an embodiment of the invention a part for an EV is provided that is comprised of a composite material, wherein the composite material includes at least one integrated thermal sensor, and wherein the thermal sensor comprises a warp knitted thermocouple as set out in any one of the embodiments described herein. In a further embodiment the invention provides an EV comprising the aforementioned part and a controller, wherein the controller is in electrical communication with at least one thermal sensor that is integrated within the structure of the part. Suitably, the part is comprised within a battery housing for an EV. Optionally, the part is made from a fibre reinforced polymer, such as carbon or glass fibre reinforced polymer. In a specific embodiment of the invention, the part comprises a fibre reinforced polymer that comprises one or more laminar structures. The laminar structures are made from a polymer fibre fabric or textile, suitably the integrated thermal sensor or a thermal sensor array is comprised within the laminar structure and may be knitted within or applied to the polymer fibre fabric or textile.

The following non-limiting examples were performed to indicate the feasibility of embedded thermal sensors within polymer resin composite materials having some or all of the above features.

### EXAMPLES

### Example 1

### Method and Materials

This experiment measured the output of a standard wire thermocouple when embedded

within a resin matrix of the type used in manufacture of composite materials. The wire thermocouple (type T) consisted of two wires connected at the hot sensing junction. These wires were Cu wire (150 μm, Tatsuta Electronic Materials) and constantan wire (0.10 mm, Scientific Wire Company). The wires were set into a resin matrix using Cristic 446 PA laminating resin. The cold junction was kept outside the resin matrix and the simple thermocouple was tested firstly at a variety of temperatures and then further compared to a commercially available thermocouple Fluke Type K thermocouple. All measurements we made by attaching outputs to a Fluke 289RMS Digital multimeter.

Three thermocouples were encapsulated in a resin block measuring approximately 27 cm×15 cm (see FIG. 4). It is noted that the temperature could not be tested above 50° C. due to the thermal capacity of the resin used and low TG associated with said resin. It is also noted that the thermocouple was just placed in a plain resin mix without any textile component. This was used to provide a simple test of the thermocouple in a solid environment where the temperature was applied indirectly to the thermocouple through the medium of an epoxy resin.

### Results

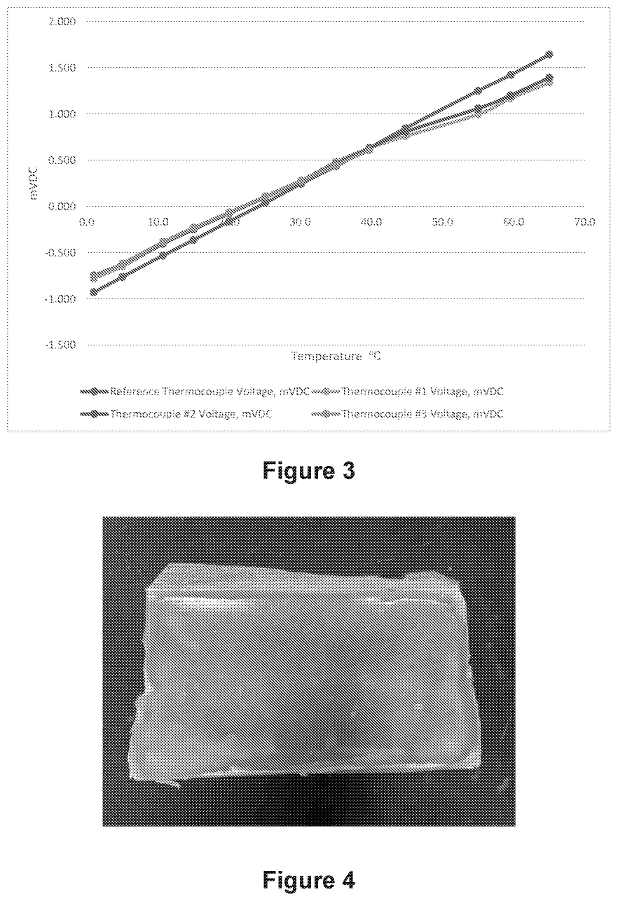

When encapsulated in a laminating resin all three solid state thermocouples work as expected (see FIG. 2). The results also show a close correlation in temperature measurement between the embedded wire thermocouples and a commercially available reference thermocouple (see FIG. 3). The small deviation in temperature reading correlation may be explained by the presence of inclusions, such as air bubbles, inside the resin mixture which allow the different thermal conductivities of air and resin to affect the measurement of temperature. This deviation is not believed to be a function of the thermocouple principle.

### Example 2

### Method and Materials

This experiment measured the output of five T-type thermocouples when embedded into a fibreglass matrix (resin and chopped strand mat). The wire thermocouples consisted of two wires connected at the hot sensor junction. These wires were copper wire (150 μm, Tatsuta Electronic Materials) and constantan wire (0.10 mm, Scientific Wire Company). The wires were set into a fibreglass matrix using EL160 high temperature epoxy laminating resin. The cold junction was kept outside the fibreglass matrix and the simple thermocouple was tested across a variety of temperatures. The output of four of the test thermocouples was also compared to a commercially available thermocouple Fluke Type K. As with Example 1, all measurements were made by attaching outputs to a Fluke 289 RMS Digital multimeter. The individual thermocouples were encapsulated in fibreglass matrix structures measuring approximately 8 cm×3 cm each (not shown).

### Results

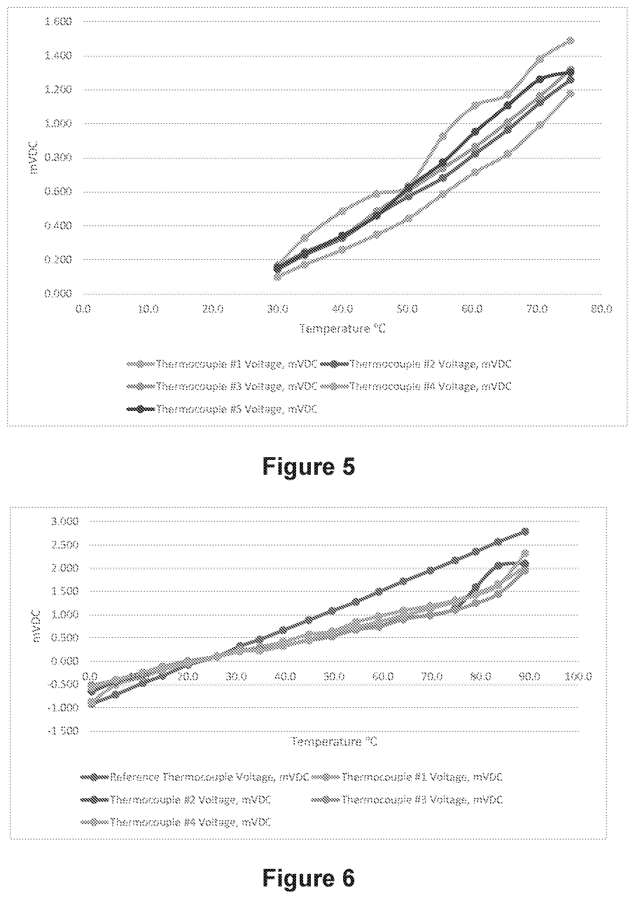

When encapsulated in a fibreglass composite matrix the solid state thermocouples work as integrated thermal sensors as expected (see FIG. 5). The results show a correlation in temperature measurement between the embedded wire thermocouples and the commercial available reference thermocouple (see FIG. 6). There is some deviation in temperature reading correlation. This may be explained by air bubbles inside the resin mixture which allow the different thermal conductivities of air and resin to affect the measurement of temperature. This deviation is not a function of the thermocouple principle.

### Discussion

The results demonstrate that thermocouples can be embedded within a composite polymer structure and provide accurate thermal sensing output data across a range of temperatures.

### Example 3

### Method and Materials

This experiment measured the output of a T-type thermocouple when embedded into a fibreglass matrix (resin and chopped strand mat). The wire thermocouple consisted of two wires connected at the hot junction. These wires were Cu wire (150 μm, Tatsuta Electronic Materials) and constantan wire (0.10 mm, Scientific Wire Company) and then said wires were set into a fibreglass matrix using EL160 high temperature epoxy laminating resin. The cold junction was kept outside the fibreglass matrix and the simple thermocouple was tested in a variety of temperatures and the output compared to the commercially available thermocouple Fluke Type K attached to Fluke 289 RMS Digital multimeter. Four individual thermocouples were encapsulated in structures measuring approximately 8 cm×3 cm each.

### Results

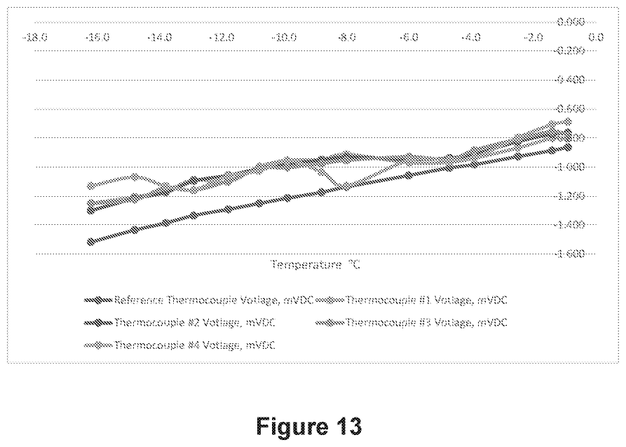

The results show a correlation in temperature measurement between the embedded wire thermocouples and the commercially available reference thermocouple (see FIG. 13). The results show a correlation between the commercial K-Type thermocouple and the T-Type thermocouples incorporated in the fibreglass matrix. There is some deviation in temperature reading correlation. As before, this may be explained by air bubbles inside the resin mixture which allow the different thermal conductivities of air and resin to affect the measurement of temperature. This deviation is not a function of the thermocouple principle. It would likely be mitigated by improved manufacture.

### Discussion

In this experiment the wire thermocouples when encapsulated in a fibreglass matrix as described above returned data similar to that of the commercial K-Type thermocouple. The temperature correlation of the trial materials was highly similar although not perfect. This will be due to a combination of factors. Firstly the fibreglass matrix samples contain some air pockets within the structure. These air pockets will have a different thermal conductivity and hence a different response to the temperature gradient as the water and salt mixture cools. In addition the hot junction of the thermocouples is not in exactly the same place in each sample and as such may be subject to temperature variations within the simple water bath. Second, a fibreglass matrix has a different value of thermal conductivity to the ice, salt and water (it is lower) and therefore the heat transfer from the water to the thermocouple will occur at a different rate. This may account for the offset in the fibreglass matrix samples to the commercially available thermocouple.

Nevertheless, the experiment provides proof of principle that a simple arrangement embedded within a resin matrix can successfully operate as a thermocouple. This supports the embodiments of the invention described above in relation to various warp stitch patterns with weft inserted conductive yarns, which would operate according to similar principles when incorporated into a composite material.

Although particular embodiments of the invention have been disclosed herein in detail, this has been done by way of example and for the purposes of illustration only. The aforementioned embodiments are not intended to be limiting with respect to the scope of the invention. It is contemplated by the inventors that various substitutions, alterations, and modifications may be made to the invention without departing from the spirit and scope of the invention.

### Example 4

### Method and Materials

This experiment measured the output of a knitted thermal sensor as described above when different types of connections were made to a detector, including a multimeter to measure the potential difference between a first electrically conductive yarn made of copper and a second electrically conductive yarn made of constantan. The knitted thermal sensor was created comprising a stitch pattern of the type shown in FIG. 9. Three different types of connections between the electrically conductive yarns of the knitted thermal sensor and the detector were made: a taped connection, a shrink-wrapped connection and a knitted connection. The thermal sensor was then placed in an oven, with the detector and the cold junction kept outside of the oven, and subjected to a controlled heating ramp at a rate of 1° C./min, with 15 minute ‘dwells’ at set temperatures of 30° C., 40° C., 50° C. and 60° C., before being allowed to cool.

### Results

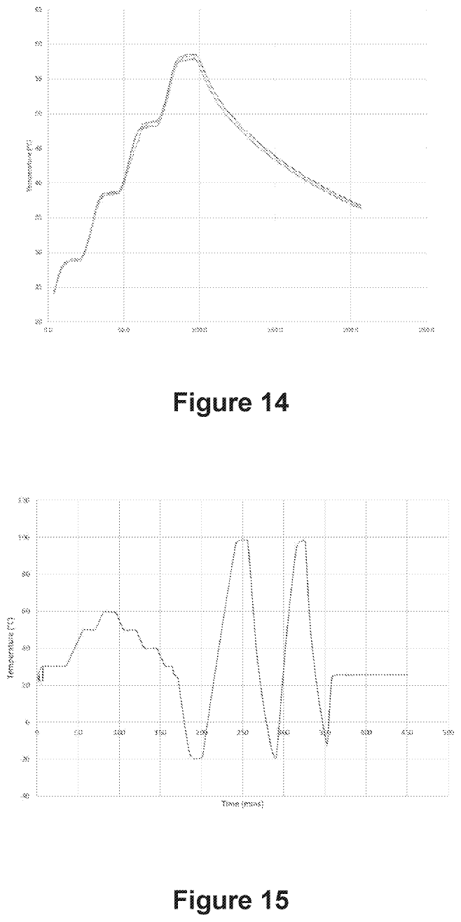

All three connection methods produced very similar results for the temperature measured by the knitted thermal sensor, as seen in FIG. 14. Each connection to the knitted thermal sensor followed the heating ramp almost identically, and stabilised at the dwell temperatures at similar rates. There knitted thermal sensor appears in this test to under-measure the temperature when compared to the temperature set by the oven by approximately 1.5° C. to 2° C. This may be due to uneven heat distribution across the volume of the oven and difference in position between the oven's own thermometer and the knitted thermal sensor.

### Discussion

The results show that the manner of connection of a detector to the knitted thermal sensor tested does not substantially alter the performance of the sensor, with accurate temperature measurement displayed across the three connection methods tested. The stitch pattern incorporated in the knitted thermal sensor appears to perform very well.

### Example 5

### Method and Materials

This experiment measured the output of a knitted thermal sensor as described above when different types of connections were made to a detector, including a multimeter to measure the potential difference between a first electrically conductive yarn made of copper and a second electrically conductive yarn made of constantan. The knitted thermal sensor was created comprising a stitch pattern of the type shown in FIG. 9. Three different types of connections between the electrically conductive yarns of the knitted thermal sensor and the detector were made: a taped connection, a soldered connection and a double-soldered connection. The thermal sensor was then placed in an oven, with the detector and the cold junction kept outside of the oven and subjected to a thermal treatment. The thermal treatment comprised ramping the temperature up from 30° C. to 60° C. and back to 30° C. at a rate of 1° C./min, with 15 minute ‘dwells’ at certain setpoints. On the ramp up, dwells occurred at 50° C. and 60° C., with further dwells at 50° C. and 40° C. on the ramp down. This was followed by ramps between-20° C. and 100° C. at increasing rates of heating and cooling: first at 3° C./min, then 6° C./min and finally at 10° C./min back to 25° C.

### Results

All three connections to the knitted thermal sensor produced near identical results, as can be seen in FIG. 15. All connections respond in substantially the same way to the different rates of heating and the dwells in the thermal treatment. The thermal sensor also shows a high level of accuracy in the temperatures measured.

### Discussion

The results here show that there is very limited difference in the temperature measurements made by the knitted thermal sensor due to the manner of the connection made with a detector. The primary objective therefore appears to be ensuring robust and durable connection to the thermal sensor, especially for sensors which are to be incorporated into composite structures, as these will be set in resin. There is also clear evidence of the accuracy of the knitted thermal sensor. While the thermal sensor in this test incorporated a stitch pattern of the type shown in FIG. 9, there is no reason to suspect that other stitch patterns, such as those based on FIGS. 10, 11 and 12 would not also perform accurately, allowing for use in a variety of application areas, such as tapes, thin composite multiaxial or unidirectional composite fibre textiles.

1. A knitted textile thermal sensor, comprising:
a first electrically conductive yarn comprised of a first electrically conductive material;
a second electrically conductive yarn that is comprised of a second electrically conductive material that is different from the first electrically conductive material; and
electrically conductive output yarns that are in electrical connection with the first electrically conductive yarn and the second electrically conductive yarn;
wherein the first electrically conductive yarn and the second electrically conductive yarn are comprised within or applied to a textile via a plurality of stitches that form a defined sensing stitch pattern,
wherein the sensing stitch pattern comprises at least one thermal sensing junction that provides an electrical connection between the first electrically conductive yarn and the second electrically conductive yarn, and at a location remote from the at least one thermal sensing junction, a reference junction, and
wherein the output yarns facilitate electrical connection to the thermal sensor such that at least one voltage measurement can be made.

2. The knitted textile thermal sensor of claim 1, wherein the textile is produced by warp knitting.

3. The knitted textile of claim 2, wherein the first electrically conductive yarn is incorporated into the textile via weft insertion.

4. The knitted textile thermal sensor of claim 1, wherein the textile is produced by weft knitting.

5. The knitted textile thermal sensor of claim 1, wherein the thermal sensor functions as a thermocouple.

6. The knitted textile thermal sensor of claim 1, wherein the textile comprises a polymer fiber.

7. The knitted textile thermal sensor of claim 6, wherein the polymer is selected from one or more of the group consisting of: polyethylene; polypropylene; polyester; polyvinylchloride (PVC); polyamide; carbon fiber; and poly-carbo-silane.

8. The knitted textile thermal sensor of claim 1, wherein the textile comprises a mineral fiber, and
wherein the mineral fiber is a silica fiber or an asbestos fiber.

9. A knitted textile, comprising: at least one integrated thermocouple sensor.

10. The knitted textile of claim 9, wherein the knitted textile comprises a plurality of integrated thermocouple sensors.

11. The knitted textile of claim 9, wherein the textile comprises a warp knitted mesh.

12. The knitted textile of claim 11, wherein the at least one integrated thermocouple sensor is comprised of one or more conductive yarns that are incorporated into the textile via weft insertion.

13. A composite material comprising the knitted textile thermal sensor of any one of claims 1 to 12.

14. A composite structure comprising the composite material of claim 13.

15. The composite structure of claim 14, wherein the composite structure is a battery housing for an electric vehicle.

16. A weft knitted textile thermal sensor, comprising:
a first electrically conductive yarn comprised of a first electrically conductive material;
a second electrically conductive yarn that is comprised of a second electrically conductive material that is different from the first electrically conductive material;
electrically conductive output yarns that are in electrical connection with the first electrically conductive yarn and the second electrically conductive yarn yarns; and
an electrical sensor;
wherein the first electrically conductive yarn and the second electrically conductive yarn are comprised within or applied to a weft knitted textile, the weft knitted textile defining a plurality of courses and wales,
wherein the first electrically conductive yarn is comprised within a first course and the second electrically conductive yarn is comprised within a second course that is spaced apart from the first course,
wherein at least one thermal sensing junction is provided by way of an electrical connection between the first electrically conductive yarn and the second electrically conductive yarn through a sensing stitch pattern that traverses the first course and the second course courses,
wherein a reference junction is provided at a location remote from the at least one thermal sensing junction, and
wherein the output yarns facilitate electrical connection to the electrical sensor such that at least one voltage measurement can be made.

17.-23. (canceled)

24. A warp knitted textile thermal sensor, comprising:
a first electrically conductive yarn comprised of a first electrically conductive material;
a second electrically conductive yarn comprised of a second electrically conductive material that is different from the first electrically conductive material;
electrically conductive output yarns that are in electrical connection with the first electrically conductive yarn and the second electrically conductive yarn; and
an electrical sensor;
wherein the first electrically conductive yarn and the second electrically conductive yarn are comprised within or applied to a warp knitted textile, the warp knitted textile defining a plurality of courses and wales,
wherein the first electrically conductive yarn is comprised within a first course and the second electrically conductive yarn is comprised within a second course that is spaced apart from the first course,
wherein at least one thermal sensing junction is provided by way of an electrical connection between the first electrically conductive yarn and the second electrically conductive yarn through a sensing stitch pattern that traverses the first course and the second course,
wherein a reference junction is provided at a location remote from the at least one thermal sensing junction, and
wherein the output yarns facilitate electrical connection to the electrical sensor such that at least one voltage measurement can be made.

25.-28. (canceled)

29. The weft knitted textile thermal sensor of claim 16 or the warp knitted textile thermal sensor of claim 24, wherein the thermal sensor comprises a single thermal sensing junction.

30. The weft knitted textile thermal sensor of claim 16 or the warp knitted textile thermal sensor of claim 24, wherein the thermal sensor comprises a plurality of thermal sensing junctions.

31. The warp knitted textile thermal sensor of claim 30, wherein the plurality of thermal sensing junctions is configured to be monitored independently of each other by the electrical sensor.
